(19) United States
(12) Patent Application Publication
(10) Pub. No.: US 2026/0120553 A1
(43) Pub. Date: Apr. 30, 2026

(54) POSTURE DETECTION METHOD, DEVICE AND NON-TRANSITORY STORAGE MEDIUM

(71) Applicant: TRIPPLE WIN TECHNOLOGY(SHENZHEN) CO.LTD., Shenzhen (CN)

(72) Inventors: Cheng-Yuan Shih, New Taipei (TW); Po-Chuan Cho, New Taipei (TW)

(21) Appl. No.: 19/188,697

(22) Filed: Apr. 24, 2025

(30) Foreign Application Priority Data
Oct. 29, 2024 (CN) 202411518220.3

(51) Int. Cl. G08B 21/04; G06T 7/73

(52) U.S. Cl. CPC G08B 21/0476; G06T 7/75; G06T 2207/10048; G06T 2207/30196

(57) ABSTRACT

Embodiments of the present disclosure relate to a posture detection method, a posture detection device and a non-transitory storage medium. The posture detection method includes acquiring first and second infrared thermal imaging images of a target scene; forming first and second human body image regions by extracting pixels corresponding to a human body from the first and second infrared thermal imaging images; and when an overlap degree between the first and second human body image regions is less than a preset overlap degree: obtaining an aspect ratio of a minimum bounding rectangle encompassing a minimum bounding ellipse of the second human body image region, obtaining an angle between a major axis of the minimum bounding ellipse and a preset vertical direction, and determining a human body posture based on the aspect ratio and the angle.

### FIELD

The subject matter herein generally relates to image processing technology, specifically a posture detection method, a posture detection device and a non-transitory storage medium.

### BACKGROUND

In a home environment, residents may fall for various reasons, and falls pose health risks especially to elderly residents. Therefore, fall detection systems can be used for home safety protection.

However, due to personal privacy protection and security issues, traditional cameras with high resolution are not suitable for highly private home settings (such as bathrooms, bedrooms, etc.).

Therefore, there is room for improvement in the art.

### BRIEF DESCRIPTION OF THE DRAWINGS

Embodiments of the present disclosure will now be described, by way of embodiment, with reference to the attached figures.

FIG. 1 is a modular diagram of a posture detection device according to an embodiment of the present disclosure.

FIG. 2 is a flowchart of a posture detection method according to an embodiment of the present disclosure.

FIG. 3 is a schematic diagram of processing of a first infrared thermal imaging image in block S1 of the flowchart shown in FIG. 2.

FIG. 4 is a schematic diagram of processing of the first infrared thermal imaging image in block S2 of the flowchart shown in FIG. 2.

FIG. 5 is a schematic diagram of a minimum enclosing ellipse and a minimum enclosing rectangle of a second human body image region in block S5 of the flowchart shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

Embodiments of the present disclosure provide a posture detection method and a posture detection device for detecting a user's posture to determine whether the user is in a fallen state and are suitable for home scenarios with high privacy requirements (e.g., bathrooms, bedrooms, etc.).

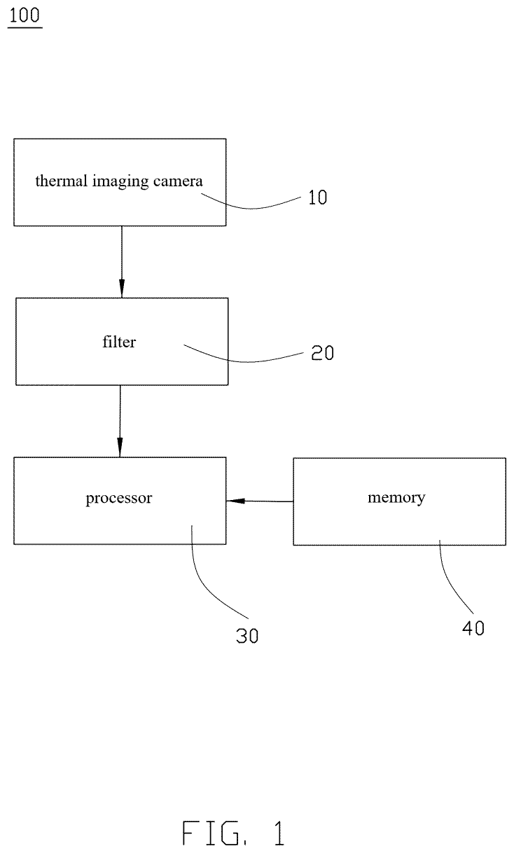

As shown in FIG. 1, the posture detection device 100 according to an embodiment of the present disclosure includes a thermal imaging camera 10, a filter 20, a processor 30, and a memory 40.

The thermal imaging camera 10 is configured to acquire infrared thermal imaging images. The filter 20 is configured to remove noise from the infrared thermal imaging images and preserve the edge contours of the infrared thermal imaging images, thereby improving image quality. The memory 40 stores a computer program which, when read by the processor 30, causes the posture detection device 100 to execute a posture detection method to detect human posture based on the infrared thermal images captured by the thermal imaging camera 10 and determine whether a person is in a fallen state.

In some embodiments, the posture detection device 100 further includes an alarm, configured to emit an alarm sound when a fall is detected, thereby promptly alerting the user.

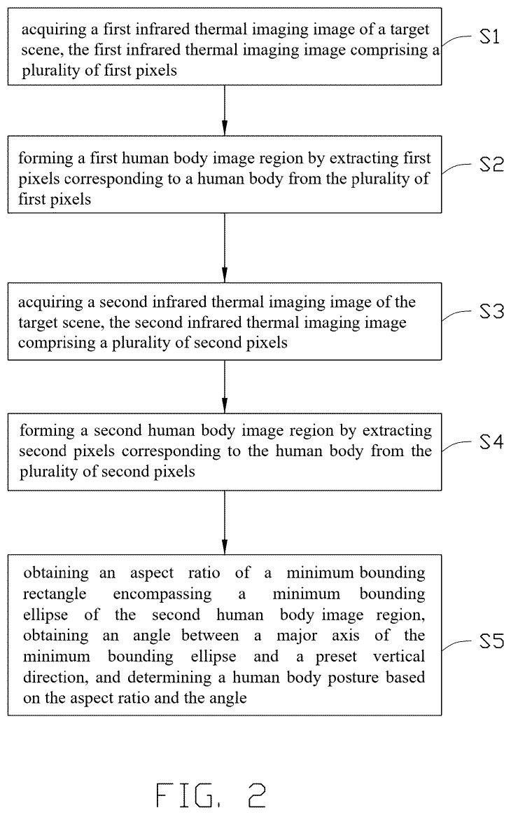

FIG. 2 shows a posture detection method provided, in an embodiment of the present disclosure, which can be implemented by the posture detection device 100. The example method is provided by way of example, as there are a variety of ways to carry out the posture detection method.

Each block shown in FIG. 2 represents one or more processes, methods, or subroutines carried out in the example method. Furthermore, the illustrated order of blocks is by example only, and the order of the blocks can be changed. Additional blocks can be added, or fewer blocks can be utilized, without departing from this disclosure. The example method can begin at block S1.

In block S1, a first infrared thermal imaging image of a target scene is acquired, and the first infrared thermal imaging image includes a plurality of first pixels.

In block S2, a first human body image region is formed by extracting the first pixels corresponding to a human body from the first infrared thermal imaging image.

In block S3, a second infrared thermal imaging image of the target scene is acquired, and the second infrared thermal imaging image includes a plurality of second pixels.

In block S4, a second human body image region is formed by extracting the second pixels corresponding to the human body from the second infrared thermal imaging image.

In block S5, an aspect ratio of a minimum bounding rectangle encompassing a minimum bounding ellipse of the second human body image region is obtained, an angle between a major axis of the minimum bounding ellipse and a preset vertical direction is obtained, and a human posture is determined based on the aspect ratio and the angle.

In block S1, the first infrared thermal imaging image can be acquired through the thermal imaging camera 10. Infrared thermal imaging mainly uses photoelectric technology to detect infrared signals of specific bands of thermal radiation of an object, converts the signals into images and graphics that can be distinguished by human vision, and can further calculate the temperature value of each pixel in the image. Therefore, in the first infrared thermal imaging image, each first pixel corresponds to a temperature value.

In one embodiment, the thermal imaging camera 10 has a low resolution, so that the acquired image has low definition, which is beneficial to protecting the user's privacy. Additionally, using the thermal imaging camera 10 with low resolution is beneficial to reducing costs.

Furthermore, to minimize the influence of external environments, a Gaussian filter or a median filter can be used to perform a first denoising process on the first infrared thermal image to filter out noise in the infrared thermal imaging data, effectively improving the quality of the image.

In one embodiment, the filter 20 is used to perform the first denoising process on the first infrared thermal imaging image, where the filter 20 is a Gaussian filter or a median filter.

In some embodiments, the block S1 further includes performing a second denoising process on the first infrared thermal imaging image after acquiring the first infrared thermal image, specifically including the following steps in blocks S11 to S13.

In block S11, the first pixels with temperature values within a preset temperature range in the first infrared thermal imaging image are extracted.

In block S12, the temperature values corresponding to the first pixels within the preset temperature range are normalized, enhancing the contrast between bright and dark parts in the first infrared thermal imaging image, thereby improving the clarity of the first infrared thermal imaging image.

In block S13, edge information in the normalized first infrared thermal imaging image is preserved and the image portions other than the edge information are smoothed.

In block S11, the preset temperature range is set according to human body temperature. The normal human body temperature range is approximately 36° C. to 37.7° C., and the preset temperature range slightly exceeds the normal human body temperature range. For example, the preset temperature range can be 20° C. to 40° C. Since the human body temperature varies with age, gender, activity, weather, medication, and other factors, the preset temperature range will change according to variations in human body temperature.

In block S13, the edge information in the first infrared thermal imaging image refers to the parts of the first infrared thermal imaging image where the surface temperature changes are most significant, also referring to the boundaries between areas with smooth grayscale changes and areas with rapid grayscale changes in the image.

Infrared thermal imaging images are formed based on thermal radiation emitted by objects, and changes in surface temperature of objects lead to differences in infrared radiation, which appear as edge information in infrared thermal imaging images.

For example, when living organisms are present in a scene, due to the different surface temperatures between living organisms and surrounding non-living materials, there are differences in infrared radiation emitted by living organisms and surrounding non-living materials, resulting in grayscale variations between the image parts corresponding to living organisms and those corresponding to surrounding non-living materials in the infrared thermal imaging image, thus creating boundaries between images of living organisms and surrounding non-living materials, and the pixels corresponding to these boundaries form edge information.

Specifically, preserving edge information in the first infrared thermal imaging image can be achieved through the filter 20, which is an edge-preserving filter. Edge-preserving filters minimize smoothing when encountering edges in the first infrared thermal imaging image while making general areas of the first infrared thermal imaging image appear smooth. In other words, edge-preserving filters preserve the edge information in the first infrared thermal imaging image and smooth the image parts other than the edge information, thereby improving the clarity and observability of the first infrared thermal imaging image.

Edge-preserving filters include bilateral filters, guided filters, and weighted least squares filters, each working on different principles. Depending on the application scenario, different edge-preserving filters can be selected to process the first infrared thermal imaging image. For example, bilateral filters are suitable for image processing tasks requiring preservation of edge details, while guided filters and weighted least squares filters are suitable for more complex image processing tasks. The specific filter selection depends on specific application requirements and image characteristics.

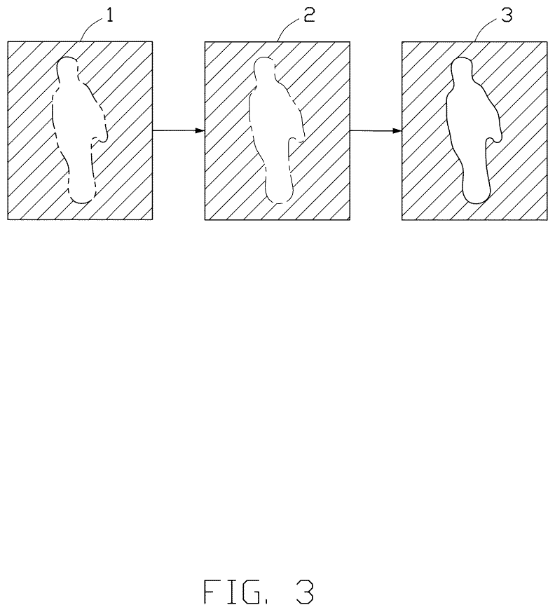

FIG. 3 shows three infrared thermal imaging images, namely infrared thermal imaging images 1, 2, and 3. Infrared thermal imaging image 1 corresponds to a first initial image without any processing mentioned in block S1, infrared thermal imaging image 2 corresponds to a first normalized image obtained after temperature value normalization (i.e., after block S12), and infrared thermal imaging image 3 corresponds to a first infrared thermal imaging image obtained after preserving edge information (i.e., after block S13).

As can be seen from FIG. 3, the number of notches in the human body edge contour lines in infrared thermal imaging image 2 is less than that in infrared thermal imaging image 1, and the number of notches in the human body edge contour lines in infrared thermal imaging image 3 is less than that in infrared thermal imaging image 2, which indicates that the clarity of infrared thermal imaging image 3 is greater than that of infrared thermal imaging image 2, and the clarity of infrared thermal imaging image 2 is greater than that of infrared thermal imaging image 1.

Therefore, after normalizing preserving edge information, and smoothing the first infrared thermal imaging image, the clarity of the first infrared thermal imaging image is improved, facilitating effective recognition of the human body in the first infrared thermal imaging image.

In other words, the thermal imaging camera 10 continuously acquires infrared thermal imaging images. In chronological order, the infrared thermal imaging images obtained by the thermal imaging camera 10 are the first infrared thermal imaging image, the second infrared thermal imaging image, the third infrared thermal imaging image, and so on. Correspondingly, the filter 20 continuously performs noise reduction and edge information preservation processing on each infrared thermal imaging image obtained.

It should be noted that in block S1, the initially obtained infrared thermal imaging image can directly undergo the second denoising processing (i.e., omitting the first denoising processing), or the initially obtained infrared thermal imaging image can undergo the second noise reduction processing after the first denoising processing, thereby enhancing image quality.

Block S2 mainly includes blocks S21 and S22.

In block S21, some first pixels corresponding to the human body in the first infrared thermal imaging image are extracted to form a first initial human body image region.

In block S22, the temperature value distribution of each first pixel in the first initial human body image region is compared with a foreground region temperature model. When the temperature value distribution of each first pixel in the first initial human body image region matches the foreground region temperature model, the first initial human body image region is reduced based on a connected components algorithm to acquire the first human body image region.

In block S21, some first pixels corresponding to the human body from the first infrared thermal imaging image are extracted based on computer vision (CV), machine learning (ML) or based on deep learning (DL) to form the first initial human body image region.

The CV and ML-based method for extracting the first initial human body image region from the first infrared thermal imaging image can be implemented using a support vector machine (SVM) classifier based on histogram of gradient (HoG) features, while the DL-based method can be implemented using a YOLO (you only look once) detector. The CV and ML-based methods require less computation and have lower hardware requirements and are suitable for simple environments. DL-based methods require more computation and have higher hardware requirements, but the execution process is simpler and suitable for complex environments.

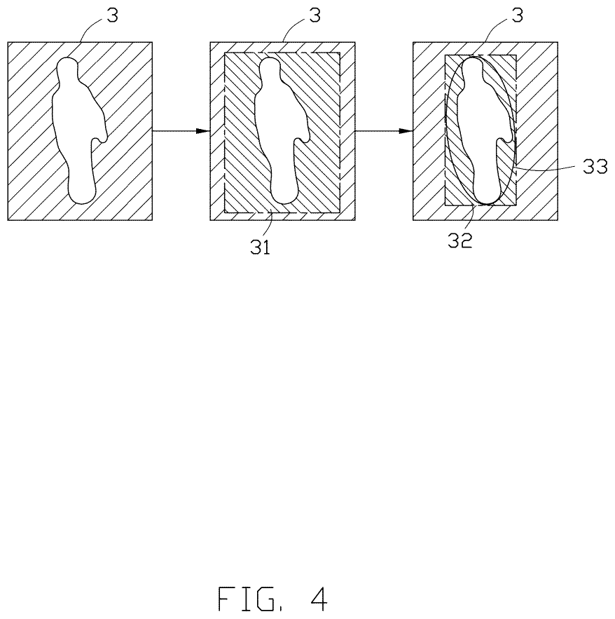

FIG. 4 shows the process of extracting first pixels corresponding to the human body from the first infrared thermal imaging image 3 to form a first human body image region 32, and the area of the first human body image region is smaller than that of the first initial human body image region. Since both CV and ML-based methods and DL-based methods have algorithmic limitations when extracting human body regions from the first infrared thermal imaging image 3, the extracted first initial human body image region 31 is relatively large.

Therefore, the connected components algorithm is used to reduce the first initial human body image region 31 to obtain the first human body image region 32, which can precisely extract the first human body image region 32 from the first infrared thermal imaging image 3, thereby improving the accuracy of the posture detection method.

In block S22, the foreground region temperature model is obtained through the following steps: acquiring a plurality of infrared thermal imaging images of the environment where the human body is located, and establishing a temperature distribution model for each pixel based on the temperature values corresponding to the pixels in the plurality of infrared thermal imaging images by using a Gaussian Mixture Model (GMM). The temperature distribution model includes a foreground region temperature model and a background region temperature model.

Since the foreground region temperature model has the same temperature distribution as the human body, and the background region temperature model has the same temperature distribution as the environment where the human body is located, comparing the temperature value distribution of each first pixel in the first initial human body image region with the foreground region temperature model ensures that the first initial human body image region contains a human body, thereby improving the accuracy of the posture detection method.

After extracting the first human body image region in blocks S21 and S22, it is necessary to fix the preset temperature and stop acquiring the foreground region temperature model to ensure that in subsequent steps, the second human body image region is extracted from the second infrared thermal imaging image under the same environment and conditions, thereby reducing system errors.

All the steps in block S2 are executed by the processor 30.

In some embodiments, block S3 further includes processing the second infrared thermal imaging image after the second infrared thermal imaging image is obtained, with the processing of the second infrared thermal imaging image being the same as the processing of the first infrared thermal imaging image in block S1.

In some embodiments, block S4 can employ the same processing as used in block S2 for extracting the first human body image region when extracting the second human body image region from the second infrared thermal imaging image.

Block S5 mainly includes blocks S51 to S55.

In block S51, the first human body image region is compared to the second human body image region.

When an overlap degree between the first human body image region and the second human body image region is less than the preset overlap degree, the second human body image region is directly output.

When the overlap degree between the first human body image region and the second human body image region is greater than the preset overlap degree, the first portion of the first human body image region that differs from the second human body image region is removed, and a second portion of the second human body image region that differs from the first human body image region is extracted, and the second portion is then merged with the first human body image region after removal of the first portion to form an updated first human body image region, which is then output as the second human body image region.

In block S52, the second infrared thermal imaging image is analyzed to determine whether there is a region in the second infrared thermal imaging image with a grayscale distribution similar to that of the first human body image region. If such a region is detected, the similar region is combined with the second human body image region and the resulting combined region is output as the second human body image region.

In block S53, the aspect ratio of the minimum bounding rectangle encompassing the minimum bounding ellipse of the second human body image region is determined, as well as the angle between the major axis of the minimum bounding ellipse and the preset vertical direction.

In block S54, the human posture is determined based on the aspect ratio and the angle. The block S54 includes the following: determining whether the angle is within the preset angle range and whether the aspect ratio is less than the preset ratio. When the angle is outside the preset angle range, the human body is determined to be in a normal state. When the angle is within the preset angle range and the aspect ratio is less than the preset ratio, the human body is determined to be in a potentially fallen state. If the human body has been in the potentially fallen state for longer than a preset time duration, the human body is determined to be in a fallen state, and an alarm is generated.

In block S51, the overlap degree is used to measure a quantity of pixels with the same grayscale in the first human body image region and the second human body image region. When the quantity of pixels with the same grayscale in the first human body image region and the second human body image region is high, the overlap degree between the first human body image region and the second human body image region is high. When the quantity of pixels with the same grayscale in the first human body image region and the second human body image region is low, the overlap degree between the first human body image region and the second human body image region is low.

Since the grayscale of each pixel in the human body image region is formed based on the temperature value corresponding to each pixel, when the grayscale of a first pixel in the first human body image region is the same as that of a second pixel in the second human body image, the temperature value corresponding to the first pixel in the first human body image region is the same as that corresponding to the second pixel in the second human body image. When hen the grayscale of a first pixel in the first human body image region is not the same as that of a second pixel in the second human body image, the temperature values corresponding to the first pixel in the first human body image region is also not the same as that corresponding to the second pixel in the second human body image.

The preset overlap degree is set based on the quantity of pixels with the same grayscale in the first human body image region and the second human body image region. When the overlap degree between the first human body image region and the second human body image region is less than the preset overlap degree, it indicates that there are few pixels with the same grayscale in the first human body image region and the second human body image region, and most temperature values corresponding to first pixels in the second human body image differ from those corresponding to second pixels in the second human body image. In this case, a temperature distribution that is different from the first human body image region exists in the second human body image region, and the second human body image region is directly output.

When the overlap degree between the first human body image region and the second human body image region is greater than the preset overlap degree, it indicates that there are many pixels with the same grayscale in the first human body image region and the second human body image region, and most temperature values corresponding to first pixels in the second human body image are the same as those corresponding to second pixels in the second human body image, and the human body temperature distribution in the second human body image region is basically the same as that in the first human body image region. In this case, the first human body image region is updated and output as the second human body image region.

Block S51 ensures that when subsequently detecting the second human body image region, the human posture in the second human body image region will not be repeatedly detected by comparing the first human body image region with the second human body image region, directly outputting the second human body image region when the overlap is low, and updating the first human body image region as the second human body image region when the overlap degree is high.

In block S52, by detecting whether there is a region in the second infrared thermal imaging image with a grayscale distribution similar to that of the first human body image region, that is, detecting whether there is a region in the second infrared thermal imaging image where the temperature distribution formed by the temperature values corresponding to multiple pixels is the same as the temperature distribution formed by the temperature values corresponding to multiple pixels in the first human body image region, it ensures that the output second human body image region includes all human body regions in the second infrared thermal imaging image, thereby improving the accuracy of the posture detection method.

If no region with a grayscale distribution similar to that of the first human body image region is detected in block S52, it indicates that there is no human body image region similar to the first human body image region in the second infrared thermal imaging image. When no such region is detected for longer than a preset lifecycle, it indicates that the human body in the first human body image region has left the current scene, at which point the determination of the human posture in the first human body image region stops. The preset lifecycle is related to a size of the scene where the human body is located. For a large scene, the preset lifecycle is long, and for a small scene, the preset lifecycle is short.

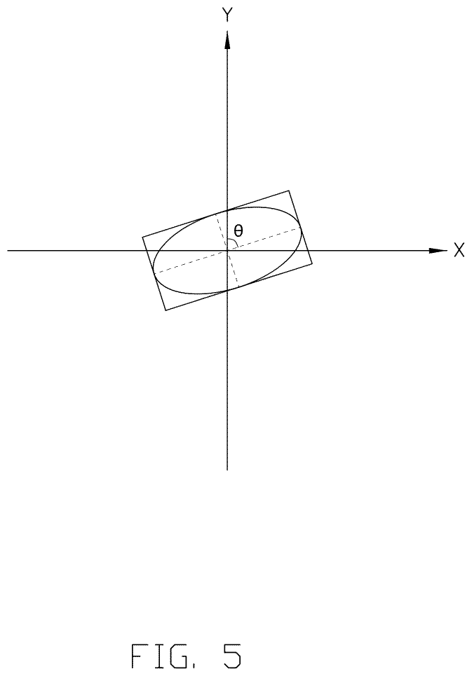

In FIG. 5, the ellipse represents the minimum bounding ellipse of a human body image region. The method for obtaining the minimum bounding ellipse is the same as obtaining the minimum bounding ellipse 33 of the first human body image region 32 in FIG. 4, which requires fitting tightly to the edge contour line of the first human body image region 32.

The rectangle in FIG. 5 is the minimum bounding rectangle of the ellipse in FIG. 5. In one embodiment, the preset angle range in block S54 is 45° to 145°, the preset ratio is 1.25, and the preset time duration is 1 second.

FIG. 5 shows the minimum bounding ellipse of the second human body image region in a Cartesian coordinate system when the human body is in a potential fall state, where the y-axis of the Cartesian coordinate system is the preset vertical direction.

In FIG. 5, the angle θ is greater than 45° and less than 145°, which is within the preset angle range. The length of the minimum bounding rectangle is the minor axis of the minimum bounding ellipse, and the width of the minimum bounding rectangle is the major axis of the minimum bounding ellipse, so the aspect ratio of the minimum bounding rectangle is less than 1.25. When the angle θ is outside the preset angle range, the length of the minimum bounding rectangle is the major axis of the minimum bounding ellipse, and the width of the minimum bounding rectangle is the minor axis of the minimum bounding ellipse. If the duration of the human body being in a potential fall state exceeds 1 second, it is determined that the human body is in a fallen state, and an alarm is issued.

The angle is the angle between the major axis of the minimum bounding ellipse and the preset vertical direction, and the preset vertical direction is the direction of the plumb line in the scene where the human body is located. When the position of the posture detection device in the scene changes, the human body image in the infrared thermal imaging images obtained by the device changes accordingly, which leads to changes in the preset angle range, preset ratio, and preset time duration. Therefore, the preset angle range, preset ratio, and preset duration are set according to changes in the position of the posture detection device in the scene.

All the above steps in block S5 are executed by the processor 30.

In summary, the posture detection method in the present disclosure utilizes infrared thermal imaging images with relatively low resolution, which can display human body contours for posture determination, while safeguarding personal security. Furthermore, not displaying human body details helps protect privacy safety in high-privacy home settings.

The posture detection method in the present disclosure also determines whether a human body is in a fallen state based on the characteristics of the minimum bounding ellipse of the second human body image region and employs a three-level alarm mechanism. Specifically, a first level alarm indicates that the human body is in a normal state, a second level alarm indicates that the human body is in a possible fall state, and when the human body has been in a potential fall state for longer than the preset duration, the system transitions from the second level alarm to a third level alarm, which indicates that the human body is in a fallen state, and an alarm is issued. Through these steps, the detection accuracy and stability are enhanced, helping to reduce the false alarm rate.

Embodiments of the present disclosure further provide a non-transitory storage medium having instructions stored thereon, when the instructions are executed by a processor of an electronic device, the processor is configured to perform the posture detection method.

When the above posture detection method is implemented and sold or used as an independent product, it can be stored in the non-transitory storage medium. Based on this understanding, all or part of the processes in the above method can be completed by instructing related hardware through a computer program, which can be stored in the non-transitory storage medium. When executed by a processor, the computer program can implement the steps of each embodiment above. The computer program includes computer program code, which can be in the form of source code, object code, executable files, or some intermediate form. The non-transitory storage medium can include: any entity or device capable of carrying the computer program code, recording media, USB flash drives, mobile hard disks, magnetic disks, optical discs, computer memory, read-only memory (ROM), random access memory (RAM), electrical carrier signals, telecommunications signals, and software distribution media.

The processor can be a central processing unit (CPU), or it can be other general-purpose processors, digital signal processors (DSP), application-specific integrated circuits (ASIC), field-programmable gate arrays (FPGA), or other programmable logic devices, discrete gates or transistor logic devices, discrete hardware components, etc. The general-purpose processor can be a microprocessor or any conventional processor. The processor is the control center of the sample processing system/sample processing device, connecting various parts of the entire sample processing system/sample processing device through various interfaces and lines.

The memory is used to store the computer program and/or modules. The processor implements various functions of the sample processing system/sample processing device by running or executing the computer program and/or modules stored in the memory and calling the data stored in the memory. The memory can mainly include a program storage area and a data storage area, where the program storage area can store operating systems, at least one application program required for functions (such as sound playback functions, image playback functions, etc.). Additionally, the memory can include high-speed random-access memory and can further include non-volatile memory, such as hard disks, internal memory, plug-in hard disks, smart media cards (SMC), secure digital (SD) cards, flash cards, at least one magnetic storage device, flash memory devices, or other volatile solid-state storage devices.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A posture detection method executed by a posture detection device, the posture detection method comprising:
acquiring a first infrared thermal imaging image of a target scene, the first infrared thermal imaging image comprising a plurality of first pixels;
forming a first human body image region by extracting first pixels corresponding to a human body from the plurality of first pixels;
acquiring a second infrared thermal imaging image of the target scene, the second infrared thermal imaging image comprising a plurality of second pixels;
forming a second human body image region by extracting second pixels corresponding to the human body from the plurality of second pixels; and
obtaining an aspect ratio of a minimum bounding rectangle encompassing a minimum bounding ellipse of the second human body image region, obtaining an angle between a major axis of the minimum bounding ellipse and a preset vertical direction, and determining a human body posture based on the aspect ratio and the angle.

2. The posture detection method according to claim 1, wherein:
the forming of the first human body image region comprises:
extracting the first pixels corresponding to the human body from the first infrared thermal imaging image to form a first initial human body image region, and
when temperature values corresponding to each of the first pixels in the first initial human body image region conform to a temperature model of a foreground region, reducing the first initial human body image region based on a connected component algorithm to acquire the first human body image region; and
the forming of the second human body image region comprises:
extracting the second pixels corresponding to the human body from the second infrared thermal imaging image to form a second initial human body image region, and
when temperature values corresponding to each of the second pixels in the second initial human body image region conform to the temperature model of the foreground region, reducing the second initial human body image region based on the connected component algorithm to acquire the second human body image region.

3. The posture detection method according to claim 2, wherein:
extracting the first pixels corresponding to the human body from the first infrared thermal imaging image to form the first initial human body image region is based on at least one of computer vision, machine learning, and deep learning; and
extracting the second pixels corresponding to the human body from the second infrared thermal imaging image to form the second initial human body image region is based on at least one of computer vision, machine learning, and deep learning.

4. The posture detection method according to claim 1, further comprising:
when an overlap degree between the first human body image region and the second human body image region is less than a preset overlap degree, directly outputting the second human body image region; and
when the overlap degree between the first human body image region and the second human body image region is greater than the preset overlap degree:
removing a first portion from the first human body image region, wherein the first portion of the first human body image region is different from the second human body image region,
extracting a second portion from the second human body image region, wherein the second portion of the second human body image region is different from the first human body image region,
merging the second portion with the first human body image region with the first portion removed to form an updated first human body image region; and
outputting the updated first human body image region as the second human body image region.

5. The posture detection method according to claim 1, when a region in the second infrared thermal imaging image with a similar color gradation distribution as the first human body image region is detected, the posture detection method further comprising:
combining the region of the second infrared thermal imaging image with the similar color gradation distribution as the first human body image region into the second human body image region to form an updated second human body image region;
obtaining an aspect ratio of a minimum bounding rectangle encompassing a minimum bounding ellipse of the updated second human body image region, obtaining an angle between a major axis of the minimum bounding ellipse of the updated second human body image region and the preset vertical direction, and determining a human body posture based on the aspect ratio and the angle based on the updated second human body image region.

6. The posture detection method according to claim 1, wherein the determining of the human body posture based on the aspect ratio and the angle comprises:
when the angle is outside a preset angle range, determining that the human body is in a normal state;
when the angle is within the preset angle range and the aspect ratio is less than a preset ratio, determining that the human body is in a potential fall state; and
when the human body remains in the potential fall state for longer than a preset time duration, determining that the human body is in a fallen state and issuing an alarm.

7. The posture detection method according to claim 1, wherein each of the plurality of first pixels and each of the plurality of second pixels corresponds to a temperature value, and wherein:
after acquiring the first infrared thermal imaging image and before forming the first human body image region by extracting the first pixels corresponding to the human body from the plurality of first pixels, the posture detection method further comprises:
extracting a portion of first pixels of the plurality of first pixels from the first infrared thermal imaging image, wherein temperature values of the portion of first pixels are within a preset temperature range,
normalizing the temperature values corresponding to the portion of first pixels,
preserving edge information in the first infrared thermal imaging image, and
extracting the first human body image region from the first infrared thermal imaging image; and
after acquiring the second infrared thermal imaging image and before forming the second human body image region by extracting the second pixels corresponding to the human body from the plurality of second pixels, the posture detection method further comprises:
extracting a portion of second pixels of the plurality of second pixels from the second infrared thermal imaging image, wherein temperature values of the portion of second pixels are within the preset temperature range,
normalizing the temperature values corresponding to the portion of second pixels,
preserving edge information in the second infrared thermal imaging image, and
extracting the second human body image region from the second infrared thermal imaging image.

8. A posture detection device comprising:
a processor, and
a non-transitory storage medium storing computer-readable instructions, which when executed by the processor, cause the processor to:
acquire a first infrared thermal imaging image of a target scene, wherein the first infrared thermal imaging image comprises a plurality of first pixels;
form a first human body image region by extracting the first pixels corresponding to a human body from the plurality of first pixels;
acquire a second infrared thermal imaging image of the target scene, wherein the second infrared thermal imaging image comprises a plurality of second pixels;
form a second human body image region by extracting the second pixels corresponding to the human body from the plurality of second pixels; and
obtain an aspect ratio of a minimum bounding rectangle encompassing a minimum bounding ellipse of the second human body image region, obtain an angle between a major axis of the minimum bounding ellipse and a preset vertical direction, and determine a human body posture based on the aspect ratio and the angle.

9. The posture detection device according to claim 8, wherein the processor is further caused to:
extract the first pixels corresponding to the human body from the first infrared thermal imaging image to form a first initial human body image region, and when temperature values corresponding to each of the first pixels in the first initial human body image region conform to a temperature model of a foreground region, reduce the first initial human body image region based on a connected component algorithm to acquire the first human body image region; and
extract the second pixels corresponding to the human body from the second infrared thermal imaging image to form a second initial human body image region, and when temperature values corresponding to each of the second pixels in the second initial human body image region conform to the temperature model of the foreground region, reduce the second initial human body image region based on the connected component algorithm to acquire the second human body image region.

10. The posture detection device according to claim 9, wherein the processor is further caused to:
extract the first pixels corresponding to the human body from the first infrared thermal imaging image to form the first initial human body image region based on at least one of computer vision, machine learning, and deep learning; and
extract the second pixels corresponding to the human body from the second infrared thermal imaging image to form the second initial human body image region based on at least one of computer vision, machine learning, and deep learning.

11. The posture detection device according to claim 8, wherein the processor is further caused to:
when an overlap degree between the first human body image region and the second human body image region is less than a preset overlap degree, directly output the second human body image region; and
when the overlap degree between the first human body image region and the second human body image region is greater than the preset overlap degree:
remove a first portion from the first human body image region, wherein the first portion of the first human body image region is different from the second human body image region;
extract a second portion from the second human body image region, wherein the second portion of the second human body image region is different from the first human body image region;
merge the second portion with the first human body image region with the first portion removed to form an updated the first human body image region; and
output the updated first human body image region as the second human body image region; and
when a region in the second infrared thermal imaging image with a similar color gradation distribution as the first human body image region is detected:
combine the region of the second infrared thermal imaging image with the similar color gradation distribution as the first human body image region into the second human body image region to form an updated second human body image region;
obtain an aspect ratio of a minimum bounding rectangle encompassing a minimum bounding ellipse of the updated second human body image region;
obtain an angle between a major axis of the minimum bounding ellipse of the updated second human body image region and the preset vertical direction; and
determine a human body posture based on the aspect ratio and the angle based on the updated second human body image region.

12. The posture detection device according to claim 8, wherein the processor is further caused to:
when the angle is outside a preset angle range, determine that the human body is in a normal state;
when the angle is within the preset angle range and the aspect ratio is less than a preset ratio, determine that the human body is in a potential fall state; and
when the human body remains in the potential fall state for longer than a preset time duration, determine that the human body is in a fallen state and issuing an alarm.

13. The posture detection device according to claim 8, wherein the processor is further caused to:
extract a portion of first pixels of the plurality of first pixels from the first infrared thermal imaging image, wherein temperature values of the portion of first pixels are within a preset temperature range, normalize the temperature values corresponding to the portion of first pixels, preserve edge information in the first infrared thermal imaging image, and extract the first human body image region from the first infrared thermal imaging image; and
extract a portion of second pixels of the plurality of second pixels from the second infrared thermal imaging image, wherein temperature values of the portion of second pixels are within the preset temperature range, normalize the temperature values corresponding to the portion of second pixels, preserve edge information in the second infrared thermal imaging image, and extract the second human body image region from the second infrared thermal imaging image.

14. A non-transitory storage medium having instructions stored thereon, when the instructions are executed by a processor of an electronic device, the processor is configured to perform a posture detection method, the posture detection method comprising:
acquiring a first infrared thermal imaging image of a target scene, wherein the first infrared thermal imaging image comprises a plurality of first pixels;
forming a first human body image region by extracting the first pixels corresponding to a human body from the plurality of first pixels;
acquiring a second infrared thermal imaging image of the target scene, wherein the second infrared thermal imaging image comprises a plurality of second pixels;
forming a second human body image region by extracting the second pixels corresponding to the human body from the plurality of second pixels; and
obtaining an aspect ratio of a minimum bounding rectangle encompassing a minimum bounding ellipse of the second human body image region, obtaining an angle between a major axis of the minimum bounding ellipse and a preset vertical direction, and determining a human body posture based on the aspect ratio and the angle.

15. The non-transitory storage medium according to claim 14, wherein:
the forming of the first human body image region comprises:
extracting the first pixels corresponding to the human body from the first infrared thermal imaging image to form a first initial human body image region, and
when temperature values corresponding to each of the first pixels in the first initial human body image region conform to a temperature model of a foreground region, reducing the first initial human body image region based on a connected component algorithm to acquire the first human body image region; and
the forming of the second human body image region comprises:
extracting the second pixels corresponding to the human body from the second infrared thermal imaging image to form a second initial human body image region, and
when temperature values corresponding to each of the second pixels in the second initial human body image region conform to the temperature model of the foreground region, reducing the second initial human body image region based on the connected component algorithm to acquire the second human body image region.

16. The non-transitory storage medium according to claim 15, wherein:
extracting the first pixels corresponding to the human body from the first infrared thermal imaging image to form the first initial human body image region is based on at least one of computer vision, machine learning, and deep learning; and
extracting the second pixels corresponding to the human body from the second infrared thermal imaging image to form the second initial human body image region is based on at least one of computer vision, machine learning, and deep learning.

17. The non-transitory storage medium according to claim 14, wherein the posture detection method further comprises:
when an overlap degree between the first human body image region and the second human body image region is less than a preset overlap degree, directly outputting the second human body image region; and
when the overlap degree between the first human body image region and the second human body image region is greater than the preset overlap degree:
removing a first portion from the first human body image region, wherein the first portion of the first human body image region is different from the second human body image region;
extracting a second portion from the second human body image region, wherein the second portion of the second human body image region is different from the first human body image region;
merging the second portion with the first human body image region with the first portion removed, to form an updated the first human body image region; and
outputting the updated first human body image region as the second human body image region.

18. The non-transitory storage medium according to claim 14, wherein when a region in the second infrared thermal imaging image with a similar color gradation distribution as the first human body image region is detected, the posture detection method further comprising:
combining the region of the second infrared thermal imaging image with the similar color gradation distribution as the first human body image region into the second human body image region to form an updated second human body image region;
obtaining an aspect ratio of a minimum bounding rectangle encompassing a minimum bounding ellipse of the updated second human body image region,
obtaining an angle between a major axis of the minimum bounding ellipse of the updated second human body image region and the preset vertical direction, and
determining a human body posture based on the aspect ratio and the angle based on the updated second human body image region.

19. The non-transitory storage medium according to claim 14, wherein the determining of the human body posture based on the aspect ratio and the angle comprises:
when the angle is outside a preset angle range, determining that the human body is in a normal state;
when the angle is within the preset angle range and the aspect ratio is less than a preset ratio, determining that the human body is in a potential fall state; and
when the human body remains in the potential fall state for longer than a preset time duration, determining that the human body has is in a fallen state and issuing an alarm.

20. The non-transitory storage medium according to claim 14, wherein: each of the plurality of first pixels and each of the plurality of second pixels corresponds to a temperature value, and wherein:
after acquiring the first infrared thermal imaging image and before forming the first human body image region by extracting the first pixels corresponding to the human body from the plurality of first pixels, the posture detection method further comprises:
extracting a portion of first pixels of the plurality of first pixels from the first infrared thermal imaging image, wherein temperature values of the portion of first pixels are within a preset temperature range,
normalizing the temperature values corresponding to the portion of first pixels,
preserving edge information in the first infrared thermal imaging image, and
extracting the first human body image region from the first infrared thermal imaging image; and
after acquiring the second infrared thermal imaging image and before forming the second human body image region by extracting the second pixels corresponding to the human body from the plurality of second pixels, the posture detection method further comprises:
extracting a portion of second pixels of the plurality of second pixels from the second infrared thermal imaging image, wherein temperature values of the portion of second pixels are within the preset temperature range,
normalizing the temperature values corresponding to the portion of second pixels,
preserving edge information in the second infrared thermal imaging image, and
extracting the second human body image region from the second infrared thermal imaging image.
